(19) United States
(12) Patent Application Publication
(10) Pub. No.: US 2023/0157921 A1
(43) Pub. Date: May 25, 2023

(54) SPINAL DISEASES TREATMENT METHOD

(71) Applicants: Valery Alexandrovich PANOV, Moscow (RU); Dmitry Evgenievich KASHKIN, Moscowskaya obl. (RU)

(72) Inventors: Valery Alexandrovich PANOV, Moscow (RU); Dmitry Evgenievich KASHKIN, Moscowskaya obl. (RU)

(21) Appl. No.: 18/057,678

(22) Filed: Nov. 21, 2022

(30) Foreign Application Priority Data
Nov. 23, 2021 (RU) 2021134094

(51) Int. Cl. A61H 1/00; A61H 1/02

(52) U.S. Cl. CPC A61H 1/008; A61H 1/0218; A61H 2205/081; A61H 2203/0456; A61H 2201/1607; A61H 2205/04

(57) ABSTRACT

Invention relates to the field of medicine, namely reflexology, manual methods for the treatment of spinal diseases as well as pathological conditions and diseases of the musculoskeletal system, nervous system, respiratory organs, blood circulation, and pelvic organs associated with a violation of its functional state. The presence of subluxations in the facet joints of the affected vertebral motor segments and the direction of displacement of the lower articular processes, as well as the place of increase in the width of the joint space, are preliminarily detected. At the same time, only the lower articular processes are corrected relative to the upper articular processes below the located vertebra. When performing blows, the pad of the middle finger of the supporting hand is placed on the spinous process of the displaced vertebra, the index or ring finger of the same hand is placed paravertebral.

### BACKGROUND

Invention relates to the field of medicine, namely reflexology, manual methods for the treatment of spinal diseases as well as pathological conditions and diseases of the musculoskeletal system, nervous system, respiratory organs, blood circulation, and pelvic organs associated with a violation of its functional state.

There is a known method of manual action on the spine in diseases of the hip joint (Patent RU 2040925, cl. IPC: A 61 N 23/00, 1995), which consists in the fact that the action is carried out from the second lumbar to the second sacral vertebra by striking the hypotenar of the first of the hand between the transverse and spinous processes of the displaced vertebra, then the proximal interphalangeal joint of the bent third finger of one hand is installed at the base of the spinous process of the vertebra from the displacement side, in the area of the metacarpophalangeal joint of this finger, a jolt is applied in the direction of the anatomical axis of the spine in the direction opposite to the displacement of the vertebra.

A positive result in the known method is achieved by returning the position of the spinous process of the displaced vertebra to the anatomical axis of the spine. However, orientation to the spinous process is not always justified and is subjective, since the spinous process often has various deformities, including congenital ones, which does not allow to accurately determine the correctness of its position relative to the axis of the spine. In addition, striking directly at the bone structures of the spine can lead to damage to them.

A method for the treatment of spinal diseases is also known (Patent RU 2100996, cl. IPC: A 61 N 23/00, 1998). The method includes the establishment of the affected side of the spine and palpation of the intervertebral space along the paravertebral line, where the nail phalanx of the finger is pressed tightly. Repeated metered blows are inflicted on the tip of the phalanx or its middle part with the edge of the hand opened or clenched into a fist. The procedures are carried out once to three times in 3-4 days. If necessary, they are repeated until the residual phenomena are eliminated.

The disadvantage of the method is its low efficiency, since it is not aimed at eliminating subluxation and restoring the anatomical position of the vertebra, but at relieving pain syndrome by relaxing tissues in the intervertebral space of altered vertebral motor segments (VMS) by blowing and thus improving blood supply in it. The method cannot be used in the treatment of spinal diseases associated with significant displacement of the vertebrae.

There is a known method of treating degenerative-dystrophic diseases of the spine by Kasyan N. A. (Patent RU 2100996, cl. IPC: A 6 N 23/00, 1998). The method consists in placing the patient on a couch in a prone position.

After determining the affected area by visual examination and palpation of the spine, manual therapy techniques are started. First, the physician places one hand on the area of the affected area, the spinous processes of the affected vertebrae are placed preferably between the second and third fingers at the level of the middle phalanges, which lie on the transverse processes and fit snugly to the spine. Then, with the edge of the palm of the other hand or its proximal edge, the physician delivers metered blows to the middle phalanges with a force of 1-60 N repeatedly for 5-10 seconds. After that, the physician shakes the patient in an upright position with a force of 60-130 N repeatedly for 5-10 seconds with simultaneous rotation.

The closest analogue is the method according to patent RU 2180826, that involves looking for subluxation injuries in facet articulations of injured vertebral column motor segments and determining direction of inferior articular process dislocations. Third fingernail phalanx cushions is placed above the spinous process of the injured vertebra. Finger nail phalanx cushions of the second and the fourth fingers are placed on the areas of displaced inferior articular process projections. Uninterrupted finger cushions contact to the processes is provided. A strike is delivered to the fingernail phalanxes with the main accent concentrated upon the third finger phalanx in the direction opposite to the inferior articular process dislocation direction accompanied by push action from the side of the third finger upon the spinous process, the second and the fourth finger acting for repairing the vertebra position. When one lower articular process is displaced, the pad of the third finger is placed over the spinous process of the affected vertebra, and the second or fourth, depending on the side of the displacement, respectively, on the projection area of the displaced lower articular process, additionally fix the spinous process of the adjacent vertebra.

The disadvantage of the latter method is both insufficient elaboration of the technique of striking with a striking hand, and, more importantly, not the best choice of the direction of striking. The previous method consisted of a vertical blow in the direction perpendicular to the patient's body, which effectively shifted the vertebra and the lower articular process of the vertebra in the right direction, but caused the patient unnecessary pain. Another disadvantage of this method is that the effect is carried out both on the spinous process, which is correct, but also on the articular processes, which creates pain for the patient, and joint bruising and irritation of the nerve root under the joint. With severe pain syndrome, this leads to a short-term increase in pain along the nerve.

The objective of the invention is to create a less painful method of manual therapeutic effect on the spine in its diseases caused by degenerative-dystrophic processes, which allows obtaining a persistent and pronounced therapeutic effect and preventing possible complications.

The technical result of the claimed method consists in reducing injury and increasing efficiency, by eliminating additional compression and traumatic blows to the area of edema, painful dislocated joint and pinched nerve root, while restoring joint mobility faster, compression of the nerve root from the displacement side during manipulation is excluded. At the same time, the reduction or elimination of the radicular syndrome is achieved with a high probability even after the first session. As a result, the maximum number of sessions is reduced by about half, for example, from 10 to 5 sessions. On average, the course of treatment includes from 2 to 5 procedures performed once a week.

Manual therapy techniques are performed, for this purpose fingers are placed on the area of the affected vertebra, followed by blows, while previously detecting the presence of subluxations in the facet joints of the affected vertebral—motor segments and the direction of displacement of the lower articular processes, as well as the place of increasing the width of the joint space (we can conditionally call it an “open” joint space). It should be noted that the correction is performed only of the lower articular processes relative to the upper articular processes below the located vertebra, due to the anatomical features and the most convenient access to the joints, their palpation and diagnosis. After that, the pad of the middle finger of the supporting (for right-handed, the left) hand is placed on the spinous process of the displaced vertebra, the index or ring finger of the same hand is placed paravertebral, while the nail phalanges of these three fingers are directed caudally (hereafter: caudal is that located closer to the tail or to the posterior end of the body; cranial or cervical is the antonym of the caudal, located closer to the head or to the anterior end of the body; medial is the middle, located closer to the median plane), with further blow with the edge of the palm of the first of the striking (for right-handed, the right) hand on the nail plate of the middle finger at an angle in the cranial-medial direction in order to push, dilute the articular surface of excessively close adjacent vertebrae within one joint (on one side of the vertebra) and reduce the articular gap on the other side of the vertebra. The widened gap can always be only on one side.

If necessary, each of the blows can be replaced by several blows of the same or lesser intensity.

After the implementation of the first action indicated above, additional action can be carried out, for which it is necessary to bypass the patient and stand on the opposite side of the displacement of the lower articular process and the increased width of the joint space. With the pad of the middle or index finger of the supporting (left) hand, rest against the lateral part of the spinous process of the corrected vertebra and strike with the edge of the palm of the striking (right) hand, clenched into a fist, on the nail plate of the finger placed in the medial-lateral direction towards the open joint space, towards the upper articular process below the lying vertebra. As a result of such actions, the alignment of the articular slits of adjacent vertebrae and the reposition of the lower articular process occurs.

The above methods exclude the use of vertical blows directly on: the displaced lower process; a swollen and inflamed joint under which the pinched nerve root is in direct contact.

It should be explained specifically that the pain of dislocation of the joint is experienced by the patient not only with nerve compression, but also with excessive friction in the joint (it can cause inflammation of the joint). That is why it is required to push apart, dilute the articular surfaces in the place of their excessive convergence. Similarly, a convergence may occur at the site of the “open” joint space, if the displacement was in the nature of an uneven skew between the right and left sides of the vertebra. Both excessive convergence and the open joint gap are a diversion from the norm and are painful.

Further clarifications of this general method are due to the fact that the shape and appearance of the joints of the spine of different departments is anatomically different. In this regard, the optimal method of exposure is chosen.

In the lumbar spine, blows for reposition of the displaced lower articular processes and correct the joint space are made only in the cranial, medial and lateral directions, depending on the side of the detected displacements (as described in the general case of the method above).

In the thoracic spine, blows for reposition of the displaced lower articular processes and correction of the joint space are made only in the caudal and lateral directions, also depending on the side of the detected displacements.

When the two lower articular processes are displaced in the cervical region, a Glisson's loop is used first, and then the lower articular processes of the displaced vertebrae are adjusted in this way.

In the cervical spine, blows for reposition are preferably made only from the side of the displacement of the lower articular processes and only in the medial—ventral direction.

For additional diagnostics and detection of an increase in the width of the joint space, radiography, MRI, or CT are used.

All blows are performed on the spinous process, and not on the joint.

### BRIEF DESCRIPTION OF THE DRAWINGS

Embodiments of the disclosure may be better understood by referencing the accompanying drawings.

FIG. 1 depicts a side view of a layout of the lumbar spine, according to some embodiments.

FIG. 2 depicts a top view of a layout of the lumbar spine, according to some embodiments.

FIG. 3 depicts a top view of the cervical spine, according to some embodiments.

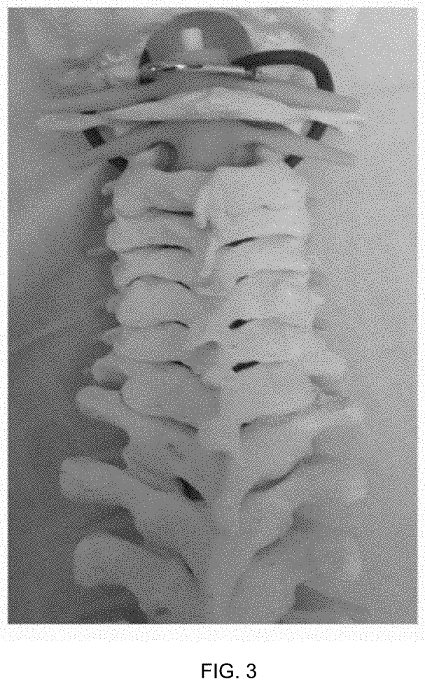

### DESCRIPTION

The description that follows includes example systems, methods, techniques, and program flows that embody aspects of the disclosure. However, it is understood that this disclosure may be practiced without these specific details.

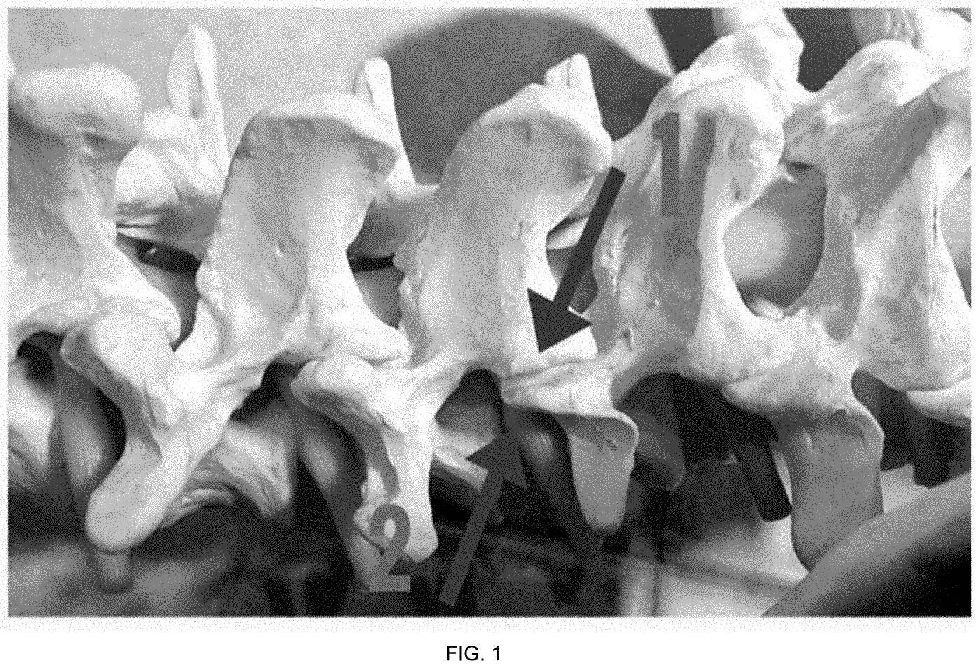

FIG. 1 depicts a side view of a layout of the lumbar spine, according to some embodiments. As shown in FIG. 1, previously, the blow was struck on arrow 1. Arrow 2 points to the nerve root under the joint. At the moment of action, the pinched root experiences an additional negative action. It takes time for him to calm down. After such a blow, a post-traumatic inflammation of the joint, its articular bag and ligaments is possible.

As already mentioned above, we start with the diagnosis and detection of articular displacement, including an increase in the width of the joint space. After that, the patient is placed on a hard, flat surface (couch, massage table, etc.) in a horizontal prone position. Rollers can additionally be placed under the patient, allowing the spine to move up and also become more prominent under the skin, and improving the palpatory diagnosis of the joint and access to its correction.

The manual therapy consists in the fact that the pad of the middle finger of the supporting (for right-handers, left) hand is placed on the spinous process of the displaced vertebra, the index or ring finger of the same hand is placed paravertebral, while the nail phalanges of these three fingers are directed caudally, after which a blow with the edge of the palm of the first clenched striking (for right-handers, right) hand on the nail plate of the middle finger is applied at an angle in the cranial-medial direction in order to push apart, to separate the articular surfaces of excessively close adjacent vertebrae within the boundaries of the joint.

If necessary, each of the blows can be replaced by several blows of the same or lesser intensity.

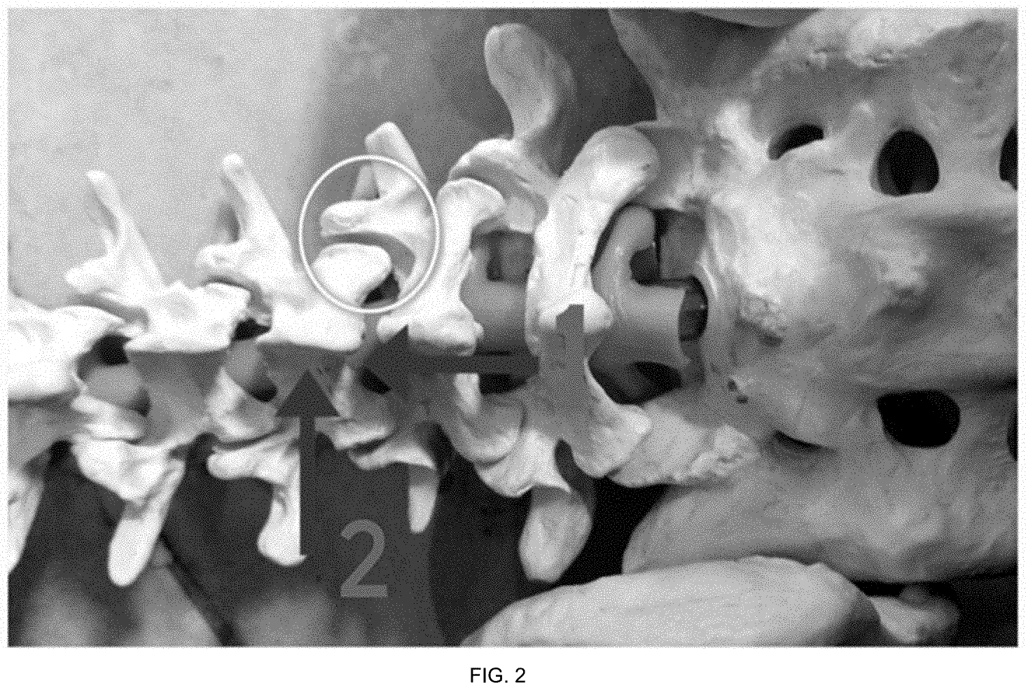

FIG. 2 depicts a top view of a layout of the lumbar spine, according to some embodiments. After the first action indicated above, additional action can be carried out from the other side, for which it is necessary to bypass the patient and stand on the opposite side of the displacement of the lower articular process and the increased width of the joint space, with the pad of the middle or index finger of the supporting (left) hand to rest against the lateral part of the spinous process (arrow 1 of FIG. 2 indicates the spinous process) of the corrected vertebra and perform a blow with the edge of the palm of the striking (right) hand, clenched into a fist, on the nail plate of the finger placed in the medial-lateral direction towards the open joint gap.

As a result of such actions, the articular slits of adjacent vertebrae are aligned and the lower articular process is reposited (arrow 2). The circle shows the place of displacement. In the lumbar spine, blows for reposition of the displaced lower articular processes and correct the joint space are made only in the cranial, medial and lateral directions, depending on the side of the detected displacements.

With this method, the correction of the joint and its joint space is performed less traumatically, since there is no additional compression and traumatic blows in the area of the pinched nerve root, possible swelling and pain of the displaced joint.

In the thoracic spine, blows for reposition of the displaced lower articular processes and correction of the joint space are made only in the caudal and lateral directions, depending on the side of the detected displacements.

When the two lower articular processes are displaced in the cervical region, a Glisson's loop is used first: the patient lies on his back, a Glisson's loop is put on his head and a short-term traction is performed with effort and a short jerk on himself, and then the lower articular processes of the displaced vertebrae are adjusted in this way.

In the cervical spine, blows for reposition are preferably made only from the side of the displacement of the lower articular processes and only in the medial—ventral direction.

After the correction, mobility is restored, pain passes during palpation of the motile motor segment. Doppler US shows straightening vertebral arteries, improving blood velocity parameters and restoring their symmetry.

At the same time, blows are inflicted only on the spinous process, and not on the joint, while any blow is inflicted not strictly vertically, but at an angle, or rather, at two angles, so that the impact vector is directed simultaneously sideways (right-left) and up-down. In this case, the direction of impact along the “up-down” vector (cranial or vertebral) depends on the spine.

### EXAMPLE 1

Patient M., 40 years old, complained of pain in the lumbar region and pulling pain along the back of the left thigh, which increases when bending. In the prone position of the patient, a diagnosis was made according to Michael and John Doherty. Pain was found of the L3-4 and L4-5 interosseous ligaments. With deeper palpation, pain was found in the area of the left L3 lower articular process, as well as its protrusions in the dorsal direction, that is, subluxation.

Examination of L4-5 articular slits revealed an increase in the width of the lumen of the joint space on the left, pain in the projection of the lower articular process on the left, as well as the presence of subluxation in the dorsal-caudal direction. When pressing on the back of the thigh of the left leg, severe pain developed. The straight leg raise test is positive.

An X-ray of the lumbar spine showed intervertebral osteochondrosis and an increase in the joint space in the left L3-4 and L4-5 segments. The diagnosis is lumbar intervertebral osteochondrosis with severe pain syndrome irradiating in the left leg.

The treatment was carried out by applying manual therapy techniques in five sessions aimed at eliminating the existing displacements (subluxations) of the lower articular processes of the affected vertebral motor segments (VMS) in the lumbar spine. In the prone position of the patient, we get up from the side of pain (open joint cracks). The pad of the middle finger of the left hand is placed on the spinous process of the third vertebra, the index finger of the left hand is paravertebral. The nail phalanges are facing in the caudal direction. With the edge of the palm of the right hand clenched into a fist, we strike the nail plate of the middle finger of the left hand in the cranial and medial direction in order to push apart, separate the articular surfaces of adjacent L3 and L4 vertebrae. After that, we move to the opposite side (to the right of the patient), with the pad of the middle finger of the left hand we rest against the lateral part of the spinous process and, by striking in the medial-lateral direction, we correct the joint space, to reduce its width. After the manipulation, we verify the absence of pain by palpation. Then we move on to the next vertebra. Manipulation is carried out similarly. At the end of the manipulation, the presence or absence of pain, bulging and protrusion of the lower articular process is palpated. With repeated pressure on the posterior surface of the left thigh, the pain decreased. An increase in the volume of movements was noted. After the fifth session, the pain is stopped. The physiological volume of movements has been restored. The straight leg raise test is negative. With deep palpation of the area of articular cracks, there is no pain. Palpation of the L3-4 and L4-5 articular slits revealed the restoration of its contour and relief. The one year follow-up showed no recurrence of spinal disease. The patient is examined once every six months.

Example 2. Patient A., 30 years old. He complained of dizziness and pain in the neck area on the right. The Doppler US of the neck showed increase in the vertebral arteries' curvature with asymmetry of blood flow. The X-ray showed osteochondrosis of the cervical spine. Examination showed restriction of movement when turning the head to the right. On palpation: pain and protrusion of the lower C5 articular process, both on the left and on the right sides. As well as pain and protrusion of the left lower C4 articular process. The treatment was carried out using manual therapy techniques in the amount of three sessions. At first, C4-5 joints were corrected. The patient is prone, his head is bent in a position on his forehead. We are on the left side of the patient.

The pad of the middle finger of the left hand is placed on the lower articular process C4. The ring finger of the same hand is placed paravertebral. The nail phalanges are directed cranially. With the edge of the palm of the right hand clenched into a fist, we strike the nail plate of the middle finger of the left hand in the medial and ventral direction, until the displacement of the articular process is eliminated. Next, we suggest that the patient turn over on his back. We put on the Glisson's loop, pull it with our hand, and make a short proximal jerk. Next, we suggest that the patient turn prone again and put his head on his forehead. We conduct a repeated palpation of the C4-5 joints on the left. The pain is gone. We proceed to palpation of joints C5-6. After the traction, we find no pain on the left in the area of the articular processes. We approach the patient on the right, palpate the articular processes C5-6 on the right-the pain still remains.

The pad of the middle finger of the left hand is placed on the lower articular process C5 on the right. The nail phalanx is directed cranially. With the edge of the palm of the right hand clenched into a fist, we strike the nail plate of the middle finger in the ventral and medial direction, to correct the joint.

After such an action, the joint is palpated again. The pain has decreased. After the second session, there is no dizziness. After the third session, there is no pain during palpation of the joints, the volume of movements is restored, there is no dizziness. Doppler US shows straightening of vertebral arteries and improvement of blood velocity. There are no complaints. The follow-up period was one year, there were no relapses of the disease, preventive examination and control is carried out every six months.

Example 3. Patient S., 30 years old. Complaints of pain between the scapulae for a month. He received treatment in a polyclinic. The diagnosis was made: osteochondrosis of the thoracic spine, exacerbation. Palpation of the fifth thoracic vertebra revealed pain on the left in the area of the lower articular process. The pain increases when pressing into the side of the spinous process (to the right). So there is an displacement here. For correction, we approach the prone patient on the right. We put the middle finger of the right hand on the lateral surface of the spinous vertebra, rest against it with the pad of the finger. The ring finger of the same hand is placed paravertebral. The nail phalanges are directed cranially.

With the other hand, clenched into a fist, we strike the nail plate of the middle finger. In this case, the blows are performed in the caudal and lateral directions from the displacement side, and from the opposite side. After the manipulation, we check and palpate the joint. There is no pain. After the correction, the patient was examined a week later. There is no pain. Palpation is painless. Physical therapy is recommended.

Example 4. Patient D., female, 43 years old. She complains on neck pain when turning the head to the right; pain between the shoulder blades when inhaling; lower back pain when bending. She was observed in the polyclinic by a neurologist. The diagnosis was made: widespread osteochondrosis. On examination: restriction of head movement when turning to the right. Palpation of the 4th cervical vertebra on the right reveals joint pain, its compaction, an increase in the joint space, and displacement in the joint. The reposition was carried out. The patient is prone. We approach from the right side, put the middle finger of the left hand over the enlarged joint gap. The index finger of the same hand is placed paravertebral. The nail phalanges are directed cranially. With the other hand, clenched into a fist, we strike the nail plate of the finger so that the joint gap closes. The blow is applied in the medial-ventral direction. After that, we perform repeated palpation of the joint of the 4th cervical vertebra. There is no pain. The range of movement has been restored. Next, we palpate the thoracic region. We detect pain and displacement of the left 3 thoracic vertebra. For correction, we approach the prone patient on the right. We put the middle finger of the right hand on the lateral surface of the spinous vertebra, rest against it with the pad of the finger. The ring finger of the same hand is placed paravertebral. The nail phalanges are directed cranially. With the other hand, clenched into a fist, we strike the nail plate of the finger. In this case, the blows are performed in the caudal and lateral directions from the displacement side, and from the opposite side. After the manipulation, we check and palpate the joint. There is no pain. When inhaling, the pain decreased. We turn to the lumbar region.

We put the roller under the stomach and begin palpatory diagnostics.

We detect pain, lateral displacement in the joint and an increase in the joint space on the left of the 4th lumbar vertebra. We approach the patient on the right. We place the middle finger of the left hand on the spinous process and strike the nail plate of the finger at such an angle that the joint gap closes. After the manipulation, we perform repeated palpation of the joint and slit. The pain has decreased significantly. Three similar sessions were conducted.

There are no complaints, the volume of movements has been restored, and palpation is painless.

1. A method for treatment of diseases of the spine caused by injuries, overloads or degenerative-dystrophic processes, the method comprising:
performing manual therapy comprising,
positioning fingers of a supporting hand on the area of the affected vertebra followed by blows, wherein the presence of subluxations in the facet joints of the affected vertebral-motor segments and the direction of displacement of the lower articular processes, as well as the place of increase in width of the joint space are preliminarily detected, while correcting only the lower articular processes relative to the upper articular processes of the lower vertebra, wherein positioning of the fingers comprises,
positioning a pad of the middle finger of the fingers when performing blows on the spinous process of the displaced vertebra,
positioning at least one of an index and ring finger of the fingers paravertebral, while the nail phalanges of the at least one of the index and the ring finger are directed caudally,
after that a blow is performed with the edge of the palm, clenched into a fist, hitting a nail plate of the middle finger at an angle;
at the same time, in the lumbar spine, performing blows in the cranial, medial and lateral directions from the displacement side and from the opposite side;
in the thoracic spine, performing blows only from the side of the displacement of the lower articular processes and only in the medial-ventral direction; and
in the cervical spine, performing blows only from the side of the displacement of the lower articular processes and only in the medial-ventral direction.

2. The method according to claim 1, further comprising:
carrying out an additional effect is carried out if necessary, wherein carrying out the additional effect comprises bypassing the patient and standing on the opposite side of the displacement of the lower articular process and the increased width of the joint space,
resting the pad of the middle or index finger of the left hand against the lateral part of the spinous process of the corrected vertebra; and
performing a blow with the edge of the palm of the right hand, compressed in the fist, along the nail plate of the finger placed, in the medial-lateral direction towards the joint space.

3. The method according to claim 1, further comprising:
when the two lower articular processes are displaced in the cervical region, performing the following while a patient lies on their back,
placing a Glisson's loop on a head of a patient;
performing traction with traction and proximal jerk; and
performing a reposition of the lower articular processes of the displaced vertebrae.
